(19) United States
(12) Patent Application Publication
(10) Pub. No.: US 2008/0163541 A1
(43) Pub. Date: Jul. 10, 2008

(54) Flying Insect Trap

(75) Inventor: Mikael Ivan Harris, Hastings (NZ)

Correspondence Address: D. PETER HOCHBERG CO. L.P.A., 1940 EAST 6TH STREET, CLEVELAND, OH, 44114, US

(73) Assignee: Bin Trap Limited, Hastings (NZ)

(21) Appl. No.: 11/884,721

(22) PCT Filed: Feb. 20, 2006
(86) PCT No.: PCT/NZ2006/000021

§ 371 Date: Aug. 20, 2007

(30) Foreign Application Priority Data
Feb. 20, 2005 (NZ) 538276

(51) Int. Cl. B65F 7/00; A01M 1/10; A01M 1/20; B65F 1/16

(52) U.S. Cl. 43/120; 43/131; 43/121

(57) ABSTRACT

A flying insect trap which is incorporated into the lid of a rubbish bin and which has a one way entry through the lid into a compartment into which an attractant/insecticide is introduced. The dead insects which have entered the trap fall onto the floor of the compartment which has a door which automatically opens when the lid of the rubbish bin is opened to discharge the dead insects from the compartment into the rubbish bin.

This application is a National Stage application of International Application No. PCT/NZ2006/000021, filed on Feb. 20, 2006, which claims priority of New Zealand application No. 538276 filed on Feb. 20, 2005.

### BACKGROUND OF THE INVENTION

1. Field of the Invention

The invention relates to a flying insect trap which is incorporated into the lid of a rubbish bin and which has a one way entry through the lid into a compartment into which an attractant/insecticide is introduced. The dead insects which have entered the trap fall onto the floor of the compartment which has a door which automatically opens when the lid of the rubbish bin is opened to discharge the dead insects from the compartment into the rubbish bin.

2. Description of the Prior Art

Flying insects and particularly flies are most unwelcome pests and present a major health hazard. It is well known to use sprays and powders for the purpose of killing the pests, but these have limited use and their effectiveness exists for a finite time. There have been many attempts to rid localities and specific areas of such pests such as providing attractants and then trapping the insects. But because of the persistence of these pests, such attempts have met with only minimal success.

Flies are generally attracted by odor and it is known that organic material and in particular household rubbish are a major attraction for the pests.

Many different types of flying insect traps have been proposed and examples of these are:

U.S. Pat. No. 6,393,760 (Lingren). The trap has a dome through which insects are lured into a capture reservoir which includes a kairomone lure dispenser and a kill bait.

U.S. Pat. No. 6,463,693 (Weisner) discloses a trap for placing on window sills. Insects which enter the trap fall into water contained within the trap and drown.

U.S. Pat. No. 6,574,914 (Smith) discloses an insect trap that uses an attracting light within a translucent cover and a fan to draw insects into the cover and to force the insects onto a sticky disposable tray.

U.S. Pat. No. 6,609,329 (McCallum) discloses an insect trap which comprises a cover to be placed over a receptacle containing insect attractant. The cover includes a screen which allows the passage of the scent of an attractant into the trap. The movement of the scent into the trap is facilitated by a means to create a low pressure area in the trap. The bait consists of water and attractant and means are provided to enable rain water to automatically top up the level of water to counteract evaporation.

U.S. Pat. No. 6,754,988 (Downey) discloses a trap having a funnel which leads to a disposable capture vessel. The funnel includes a spring loaded clip which joins the funnel to the capture vessel which includes a bait element.

U.S. Pat. No. 6,772,556 (Liu) discloses a housing having an opening. A layer of parallel strings is stretched over the opening with the distance between the strings corresponding to the width of the body of the target insect which prevents the insect from escaping the housing. An attractant is located within the housing.

U.S. Pat. No. 6,786,001 (Piper) discloses an insect trap which has a translucent cover to seal a casing. The cover has an opening in the form of an insect entry port to the casing. The casing includes a light source to attract the insects through the translucent cover.

U.S. Pat. No. 5,685,109 (Rimback) discloses an insect trap which includes a liquid hydrocarbon bait and a solid protein bait. The trap has a pair of opposing panels with a number of insect entrances. The side panels engage with each other and form an enclosed area in conjunction with a central tray into which the insects are trapped.

U.S. Pat. No. 5,522,171 (Mendevillea) discloses an insect trap which utilises two symmetrical jars joined in line and face to face by a cylindrical collar which has a number of insect entry ports. An insect entering the collar portion is attracted by the lighted area of one of the jars which it can enter through a restricted opening.

U.S. Pat. No. 5,392,560 (Donahue) discloses a three piece insect trap which has a hollow bait container with a neck having insect openings. Insects are directed upwardly into a transparent top cover having a bait onto which the insects will land. The insects are trapped within the top cover.

U.S. Pat. No. 4,930,251 (Crisanti) discloses an insect trap having a housing with a top which is removable from a base which includes openings for insects. The interior of the housing is coated with an adhesive layer to trap the insects.

U.S. Pat. No. 4,505,065 (Niemeyer) discloses an insect trap which has an insect attractant inside a hollow body. A number of apertures are formed in a wall of the body with each aperture having a flap-like projection which enables the insects to enter the body and be attracted into a portion in which the insects are collected.

U.S. Pat. No. 1,607,249 (Dyer) discloses a combination garbage can lid and flytrap. The lid/flytrap is constructed to be located on the top of a rubbish bin. The trap has a floor with perforations to allow effluvia in the rubbish bin to rise through the perforations into the fly trap to act as an attractant for the flies. The interior of the trap is free from contact with the refuse in the garbage can.

None of the prior art insect traps include means which will attract the insects, exterminate the insects and automatically dispose of the insects.

### SUMMARY OF THE INVENTION

It is therefore an object of this invention to provide a trap for flying insects which will overcome or at least minimise the above disadvantages.

In one form the invention is an insect trap adapted to be incorporated into a lid of a rubbish bin, wherein the trap includes:

an entry port located in the lid and which communicates with a one way duct system beneath the lid,

a compartment in communication with the one way duct adapted to receive flies that pass through the entry port and the one way duct system,

structure to retain dead insects within the compartment while the lid of the rubbish bin remains closed and to be discharged from the compartment into the rubbish bin when the lid is opened, and

structure to introduce a poison into the compartment in a manner that insects that enter the compartment through the entry port and one way duct system will contact the poison.

Preferably the trap includes an insect attractant associated with the trap.

Preferably the compartment includes a collection area for dead insects.

Preferably the structure to retain the insects within the compartment and to discharge the dead insects when the lid of the rubbish bin is opened comprises a discharge door which seals an exit between the interior of the compartment and the rubbish bin when the lid is closed and which will open to unseal the exit to allow the dead insects held within the compartment to be discharged into the rubbish bin when the lid is opened on the rubbish bin.

Preferably the discharge door is held in a closed position by gravitational forces when the lid is closed and opens by reason of gravitational forces when the lid is opened.

Preferably the one way duct system includes structure to prevent insects after they have passed through the duct from passing back through the duct.

Preferably the preventing structure includes funneled ports with the exits from the ports being shielded by structure for restricting re-entry of insects within the cavity into the funneled ports.

Preferably the restricting structure comprises a plurality of hairs.

Preferably the structure to introduce poison into the compartment comprises a reservoir to retain the poison, said reservoir communicating with a pump which is located so that when the lid is raised the pump will be primed with poison from the reservoir and when the lid is closed, the pump will force the poison that has primed the pump into the compartment.

Preferably the poison includes a sex attractant.

Preferably the poison includes a food attractant.

In another form the invention is an insect trap adapted to be incorporated into a lid of a rubbish bin, and including;

a chamber in the lid of the rubbish bin, the chamber having an entry port which communicates with a compartment within the chamber,

a one way port which will allow insects to pass from the entry port into the compartment,

structure within the chamber adapted to receive a container for attractant/insecticide, the container being arranged to dispense a controlled amount of the attractant/insecticide onto a curtain located within a compartment within the chamber

the compartment having a floor onto which dead insects will fall and having a discharge door which when the lid is closed will remain closed and when the lid is opened will allow the insects lying on the floor of the compartment to be discharged into the rubbish bin,

the compartment also having walls which include air vents to enable air within the rubbish bin to permeate into the compartment, past the curtains, through the one way ports and out of the entry port.

Preferably a collection point onto which the dead insects will fall is formed in the floor of the compartment.

Preferably the walls of the compartment include air vents.

Preferably cavity is included in the chamber which can receive a container for an insect attractant and an insecticide.

Preferably the container is arranged to allow the attractant and insecticide to be ejected from the container in a controlled manner.

Preferably the attractant/insecticide will fall onto and be absorbed by a curtain within the compartment.

Preferably the discharge door is held in a closed position by gravitational forces when the lid is closed.

Preferably a window is formed in the chamber to allow light to enter the trap.

### BRIEF DESCRIPTION OF THE DRAWINGS

FIG. 1 is a view from above of the insect trap located on a rubbish bin.

FIG. 2 is a view of a typical entry port.

FIG. 3 is a view of the entry port one way system.

FIG. 4 is a view from one side of the insect trap in a raised position when located on the bin.

FIG. 5 is a plan view of the compartment and poison dispenser of the insect trap.

FIG. 6 is a three quarter side view of a rubbish bin lid similar to that illustrated in FIG. 1 but with a modified form of the insect trap.

FIG. 7 is a sectional view along the lines 7-7 of FIG. 6.

FIG. 8 is a side view of the lid illustrated in FIG. 6.

FIG. 9 is a sectional view along the line 9-9 of FIG. 7 of the lid when applied to a rubbish bin.

### DETAILED DESCRIPTION OF THE PREFERRED EMBODIMENTS

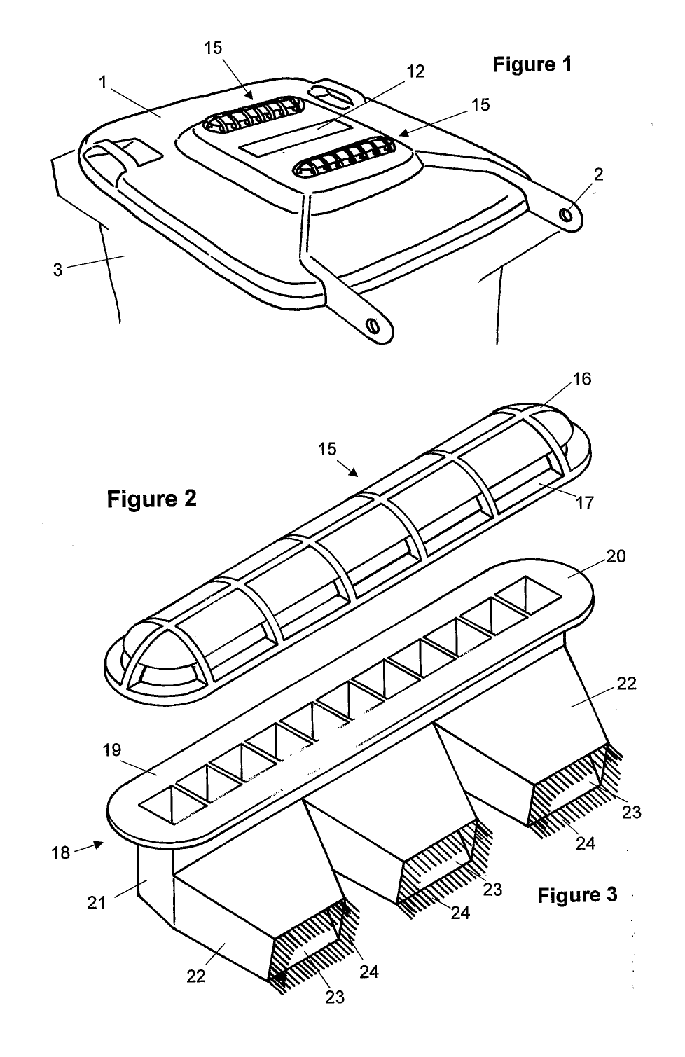

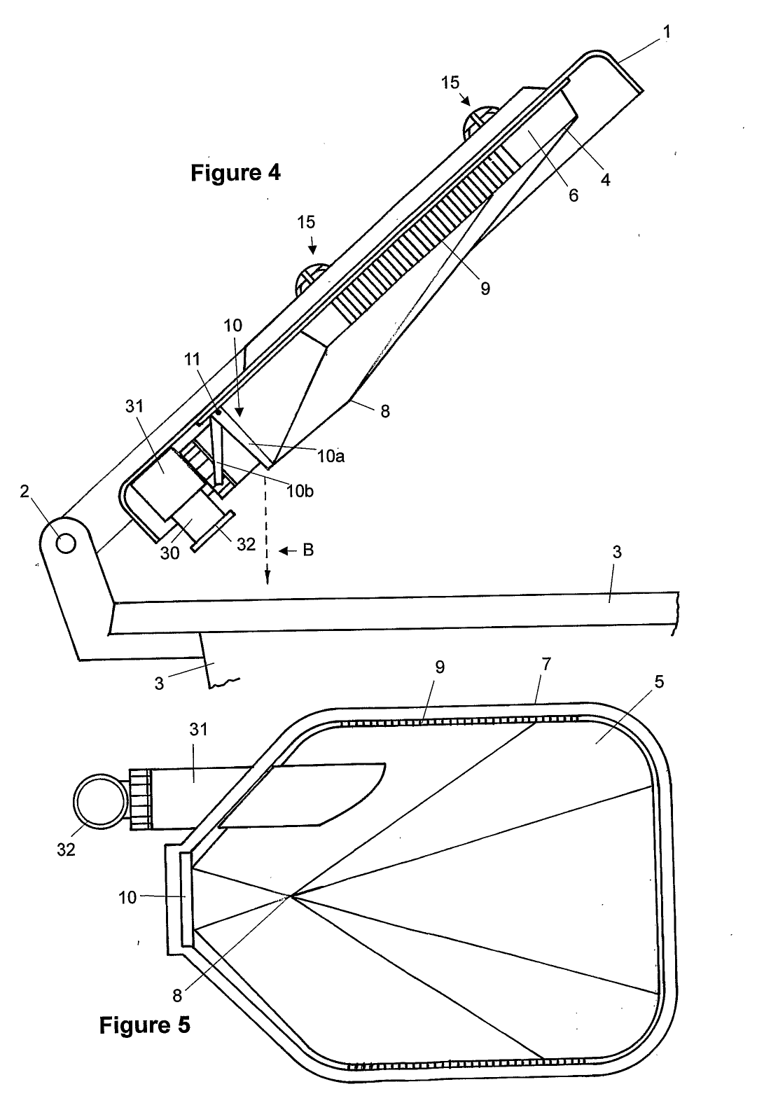

The insect trap as illustrated in FIGS. 1 through 5 of the drawings consists essentially of a construction which is fitted to a rubbish bin lid which is pivoted, such as at 2 to a typical rubbish bin 3, often referred to as a “wheelie bin”. The trap includes a compartment 4 which is preferably shaped as illustrated and has a floor 5 and sides 6 and also a perimeter 7 by which the compartment can be appropriately attached to the underside of the lid. This construction provides a cavity between the underside of the lid 1 and the floor of the compartment 4. Preferably also the compartment is shaped as illustrated particularly in FIG. 4 to form a collection point 8 on the floor for dead flies and other insects which may enter the trap. The sides 6 of the compartment also have a series of air vents holes 9 to enable effluvia in the rubbish bin to rise into the cavity.

The cavity between the compartment 4 and the lid 1 is provided with an outlet which is normally closed by a discharge door 10 which is pivoted at 11 to the compartment in a manner that when the lid of the bin is closed, such as that illustrated in FIG. 1, the door will pivot under the influence of gravity to a closed position 10a to close off the outlet to the compartment. When the lid 1 is lifted to a position such as that illustrated in FIG. 3, the door 10 will pivot to an open position 10b and any dead insects that may be in the cavity and/or on the compartment floor, will be discharged by gravity as indicated by the arrow B in FIG. 3 from the compartment into the interior of the rubbish bin.

The trap is provided with one or more entry ports 15, see FIG. 3. A typical formation of an entry port is illustrated in FIG. 2 which consists of a convex cover 16 which has a base whereby the cover can be secured such as by adhesive to the lid 1 which has appropriate slots (not shown in the drawings) which will register with the hollow interiors of the entry ports 15. The entry ports 15 are provided with portals 17 which are preferably of a size that will allow smaller flying insects such as flies to enter the port but obstruct the entrance of larger flying insects.

A one way duct system 18 is constructed to have a connecting surface 19 by which the one way duct system can be attached such as by an adhesive to the underside of the lid so the duct 20 of the one way duct system 18 will register with the slots in the lid and with the interior of the entry ports 15. Preferably but not necessarily the duct 20 is divided into channels by walls 21 and as illustrated the channels are directed into funneled ports 22 which have exits 23. The exits are also preferably provided with a shield 24 which may consists of a plurality of hairs or the like, the purpose of which is to allow free one way movement of the insect through the funneled ports, but not allow insects to return into the ports. Although the drawings illustrate three separate funneled ports 22, it is to be understood this is one preferred construction and various constructions can be utilised which will allow the free, one way, movement of insects out of the funneled ports.

Preferably also a window 12 is provided in the lid to enable light to enter the cavity of the trap. The window not only allows inspection of the interior of the trap so the user can be assured the trap is actually working but also provides a further attractant for insects that may enter the trap. The light from the window will tend to draw the insects that have entered the duct to proceed further into the cavity through the one way duct and the shield to enter into the cavity of the trap.

The trap also includes structure to insert or dispense poison such as an insecticide or the like and preferably also an insect attractant into the cavity of the trap. One preferred structure comprises an automatic system which can be in the form of a pump 30 connected to a container such as a bottle 31 which can be charged with a suitable insecticide or other approved poison. The pump 30 is provided with an actuating knob 32 or the like with the pump and the knob being located so that when the lid of the rubbish bin is opened, the pump will be automatically primed and when the lid is closed, the actuating knob 32 will contact a ledge or the like to thereby depress the piston within the pump to force the contents of the pump out of the pump and into the cavity of the trap. Various types of insecticide and/or other poisons can be utilised to provide effective killing of any flying insect that may enter the trap.

The trap may also include a device to inject a short dose of the insecticide into the bin whenever the lid of the bin is closed. This device can be coupled to or part of, the pump 30.

Preferably the attractant/insecticide is in the form of a multiple point attractant in that it is also a sex attractant for both sexes of flying insects as well as being a food attractant. Preferably also the amount of poison that is dispensed by the pump can be varied since bins which are in less frequent use may require injections of larger doses of poison.

The trap is so constructed that when the lid of the rubbish bin is closed, effluvia within the rubbish bin will permeate through the vent holes 9 in the compartment and a small amount can trickle out of the entry ports to provide an attractant for flying insects. The insects can enter the trap through the portals 17 and will find their way into the interior of the trap where they will contact the insecticide and be exterminated. The insects will then fall onto the floor 5 of the compartment and because of the formation of the floor will tend to collect at the collection point 8 on the compartment. It is to be understood that while the lid of the rubbish bin remains closed, the only entry/exit into the cavity of the trap is through the portals because the discharge door 10 will remain closed under the influence of gravity. When the lid of the rubbish bin is lifted, the discharge door will open and any dead insects will be discharged through the door and fall into the rubbish bin. The lifting of the lid will also prime the pump so that when the lid is allowed to close, the pump will be actuated and a shot of the insecticide will be dispensed into the cavity of the trap.

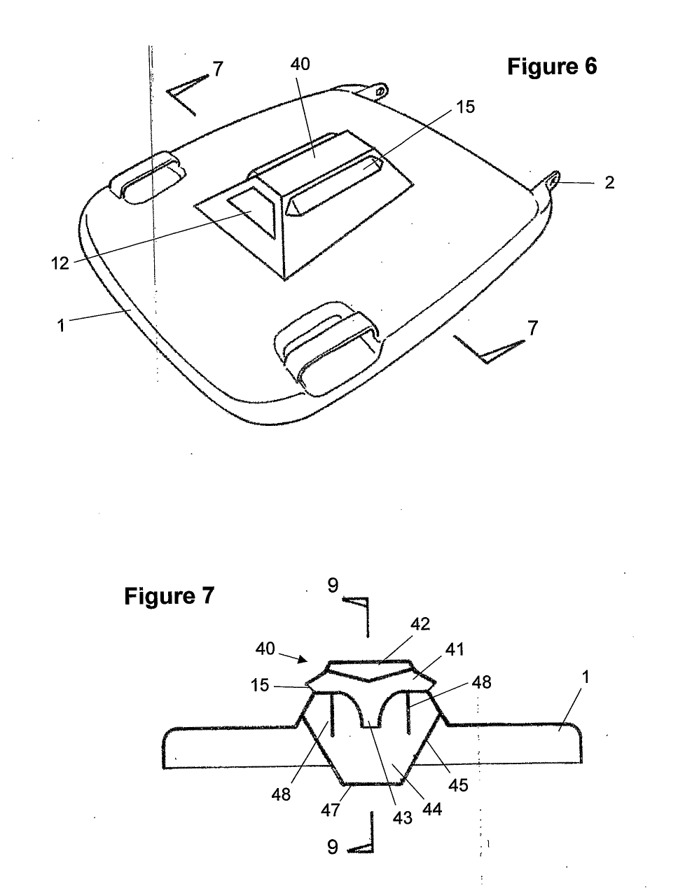

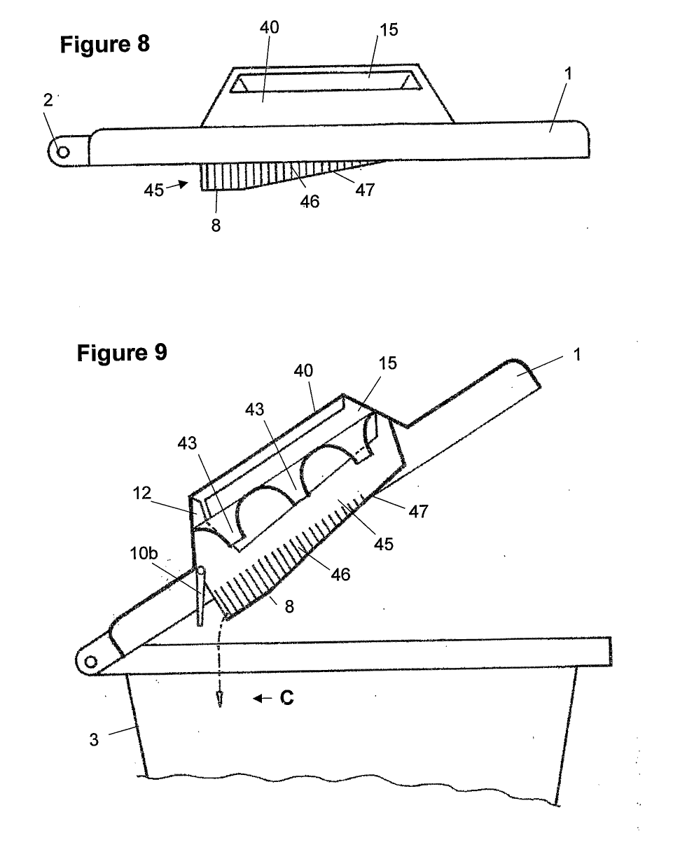

In the modification illustrated in FIGS. 6 through 9, like components have been designated with the same reference numbers as in the modification illustrated in FIGS. 1 through 5.

As illustrated in FIG. 6 through 9, the lid 1 is pivoted at 2 to a typical rubbish bin 3 (see FIG. 9) and includes one or more entry ports 15 formed in a chamber 40 which projects upwardly from the surface of the lid 1. The chamber can be formed as part of the lid or can be attached later after a suitable cut out (not shown in the drawings) is formed in the lid. The interior 41 (see FIG. 7) of the chamber includes a cavity 42 to receive a container of attractant/insecticide. The remainder of the interior 41 of the chamber is sealed from the interior of the rubbish bin except for one or more entry ports or funnels 43 which are so formed that insects which enter the interior of the chamber 40 through the entry ports 15 can pass through the ports 43 into the compartment 44 of the chamber 40 but cannot re-enter the interior 41 of the compartment 44. The sides of the entry ports 43 are preferably perforated or otherwise formed to assist in the flow of air into and through the ports.

The side walls 45 of the compartment 44 are preferably formed with air vents 46 to allow air to flow from the interior of the rubbish bin to flow through the vents into the compartment 44, through the one way ports 43 and out of the entry ports 15.

The compartment 44 has a floor 47 which includes a collection point 8 onto which insects which have succumbed to the insecticide will fall. The compartment further includes a door 10b so that when the lid is lifted as illustrated in FIG. 9, any insects on the collection point of the compartment will be discharged from the compartment into the interior of the rubbish bin as indicated by the arrow C in FIG. 9.

As illustrated more particularly in FIG. 7, the interior of the lid includes a cavity 42 to receive a suitable container (not shown in the drawings) which contains a known form of insect attractant and also an insecticide. The container is arranged so that the attractant/insecticide can constantly drip out of the container in a controlled manner and the attractant/insecticide so discharged will fall onto and be absorbed by the curtain or curtains 48 which are formed of a suitable absorbent material.

The particular advantage of the modification illustrated in FIGS. 6 through 9 is that the trap does not rely on the contents of the rubbish being sufficiently malodorous to attract insects since the attractant/insecticide in the container within the cavity 42 will supply that requirement. In addition because of the location of the container for the attractant/insecticide, it can be readily replaced as desired.

The trap of this invention provides considerable advantages over known traps. Apart from the occasional replenishment of the poison within the bottle 31 (see FIGS. 4 and 5), or the replacement of the container with the attractant/insecticide (see FIGS. 6 through 9), no other action is required. Because of the construction of the trap, flying insects are attracted to the trap by the odor of the rubbish within the rubbish bin and/or by the attractant/insecticide. If desired further attractants such as appropriate colouring can also be employed. Once the insects are inside the trap, the insects cannot escape and are quickly killed by the action of the insecticide and the insects then fall onto the floor of the compartment 45 and remain there. Whenever the lid of the rubbish bin is opened, a discharge door will, under the influence of gravity, open and the dead insects within the compartment will be deposited see the arrow B of FIG. 3 and the arrow C of FIG. 9, into the interior of the rubbish bin ready for disposable when the bin is emptied.

Having described preferred methods of putting the invention into effect, it will be apparent to those skilled in the art to which this invention relates, that modifications and amendments to various features and items can be effected and yet still come within the general concept of the invention. It is to be understood that all such modifications and amendments are intended to be included within the scope of the present invention.

1. An insect trap adapted to be incorporated into a lid of a rubbish bin, wherein the trap includes:
an entry port located in the lid and which communicates with a one way duct system beneath the lid
a compartment in communication with the one way duct adapted to receive flies that pass through the entry port and the one way duct system
means to retain dead insects within the compartment while the lid of the rubbish bin remains closed and to be discharged from the compartment into the rubbish bin when the lid is opened,
means to introduce a poison into the compartment in a manner that insects that enter the compartment through the entry port and one way duct system will contact the poison.

2. The insect trap of claim 1, including an insect attractant associated with the trap.

3. The insect trap of claim 1, wherein the compartment includes a collection area for dead insects,

4. The insect trap of claim 1, wherein the means to retain the insects within the compartment and to discharge the dead insects when the lid of the rubbish bin is opened comprises a discharge door which seals an exit between the interior of the compartment and the rubbish bin when the lid is closed and which will open to unseal the exit to allow the dead insects held within the compartment to be discharged into the rubbish bin when the lid is opened on the rubbish bin.

4. The insect trap of claim 1, wherein the discharge door is held in a closed position by gravitational forces when the lid is closed and opens by reason of gravitational forces when the lid is opened.

5. The insect trap of claim 1, wherein the one way duct system includes means to prevent insects after they have passed through the duct from passing back through the duct.

6. The insect trap of claim 5, wherein the one way duct system includes funneled ports with the exits from the ports being shielded by means which restrict re-entry of insects within the cavity into the funneled ports.

8. The insect trap of claim 1, wherein the shielding means comprises a plurality of hairs.

9. The insect trap of claim 1, wherein the means to introduce poison into the compartment comprises a reservoir to retain the poison, said reservoir communicating with a pump which is located so that when the lid is raised the pump will be primed with poison from the reservoir and when the lid is closed, the pump will force the poison that has primed the pump into the compartment.

10. The insect trap of claim 1, wherein the poison includes a sex attractant.

11. The insect trap of claim 1, wherein the poison includes a food attractant.

12. An insect trap adapted to be incorporated into a lid of a rubbish bin, and including;
a chamber in the lid of the rubbish bin, the chamber having an entry port which communicates with a compartment within the chamber,
a one way port which will allow insects to pass from the entry port into the compartment,
means within the chamber adapted to receive a container for attractant/insecticide, the container being arranged to dispense a controlled amount of the attractant/insecticide onto a curtain located within a compartment within the chamber
the compartment having a floor onto which dead insects will fall and having a discharge door which when the lid is closed will remain closed and when the lid is opened will allow the insects lying on the floor of the compartment to be discharged into the rubbish bin,
the compartment also having walls which include air vents to enable air within the rubbish bin to permeate into the compartment, past the curtains, through the one way ports and out of the entry port.

13. The insect trap of claim 12, wherein a collection point onto which the dead insects will fall is formed in the floor of the compartment.

14. The insect trap of claim 12, wherein the walls of the compartment include air vents

15. The insect trap of claim 12 including as cavity in the chamber which can receive a container for an insect attractant and an insecticide.

16. The insect trap of claim 15, wherein the container is arranged to allow the attractant and insecticide to be ejected from the container in a controlled manner.

17. The insect trap of claim 15 wherein the attractant/insecticide will fall onto and be absorbed by a curtain within the compartment.

18. The insect trap of claim 12, wherein the discharge door is held in a closed position by gravitational forces when the lid is closed.

19. The insect trap of claim 12 including a window located in the chamber to allow light to enter the trap.
